(19) United States
(12) Patent Application Publication
(10) Pub. No.: US 2006/0020062 A1
(43) Pub. Date: Jan. 26, 2006

(54) Epoxidized esters of vegetable oil fatty acids as reactive diluents

(76) Inventor: Paul D. Bloom, Decatur, IL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/176,633

(22) Filed: Jul. 8, 2005

Related U.S. Application Data
(60) Provisional application No. 60/585,888, filed on Jul. 8, 2004.

(51) Int. Cl. C08K 5/15

(52) U.S. Cl. 524/114

(57) ABSTRACT

The present invention is directed to compositions containing epoxidized esters of vegetable oil fatty acids, and to methods of making such compositions. The esters are C₁₋₆ alkyl or C₂₋₆ alkenyl, monoglycerol or diglycerol, C₄₋₆ polyol or glycol esters of a vegetable oil fatty acid. The compositions include latex coating compositions comprising the epoxidized esters; epoxy resin compositions comprising the epoxidized esters; thermoset plastic compositions comprising the epoxidized esters; and PVC compositions comprising the epoxidized esters. The invention is also directed to epoxidized monoglycerides or diglycerides, and expoxidized C₄₋₆ polyol esters of vegetable oil fatty acids.

### CROSS REFERENCE TO RELATED APPLICATIONS

This application claims the benefit of U.S. Provisional Application No. 60/585,888, filed Jul. 8, 2004, the contents of which are entirely incorporated by reference herein.

### BACKGROUND OF THE INVENTION

1. Field of the Invention

This invention relates to compositions comprising epoxidized esters of vegetable oil fatty acids and methods of preparing such compositions. Such compositions include latex coating compositions, epoxy resin compositions, thermoset plastic compositions and polyvinyl chloride compositions.

2. Related Art

Epoxidation of soybean and linseed oils is well known in the art and is performed on a commercial scale. Epoxidized oils have desirable light and heat stabilizing properties. They are used as plasticizers and stabilizers in certain polymers. For example, epoxidized oils are used in polyvinyl chloride polymers.

Common fatty acid epoxidation employs a strong catalyst (e.g. sulfuric acid), oxidant (e.g. H₂O₂), and a carboxylic acid. Adequate agitation and temperature control of the reaction vessel is preferred for conducting an epoxidation reaction. See Chapter 10 in Recent Developments in the Synthesis of Fatty Acid Derivatives, Eds. G. Knothe and J. Derksen, AOCS Press, Champaign, Ill., 1999, pp. 157-159.

Common reactive diluents for epoxy resins include butyl glycide ether, C₁₂₋₁₄ aliphatic glycidyl ethers, cresyl glycidyl ether and 2-ethylhexyl glycidyl ether. Reactive diluents are added to epoxy resins for a number of reasons such as: cost reduction; decrease resin viscosity; and modification of cured resin properties. Reactive diluents often permit higher filler loading and better wetting of pigments. In addition, reactive diluents are important to achieve good bonding/surface wetting during impregnation of composite resins with fillers. The diluents contribute substantial reduction in viscosity and have similar reaction rates as the epoxy resins.

Propylene glycol monoesters (PGMEs) are effective coalescing aids in latex paints. PGMEs help reduce the volatile organic compound (VOC) levels in latex paint by replacing VOC coalescing solvents. Nonvolatile fatty acid esters for use in coatings are described in Van de Mark et al. (U.S. Patent Application Publication No. 20040039095). Conventional coalescents aid film formation of latex paints by acting as a plasticizer to reduced the glass transition temperature (Tg) of the latex polymer. The polymer particles can then flow together to form a continuous film. After film formation, the coalescent will evaporate slowly from the coating. After evaporation, the Tg of the polymer increases and the coating hardens. Unsaturated fatty acid ester coalescents do not evaporate from the coating. Instead, they undergo oxidative curing and have the ability to react with other components in the coating system.

### BRIEF SUMMARY OF THE INVENTION

The present invention is directed to compositions containing epoxidized esters of vegetable oil fatty acids, and to methods of making such compositions. The esters are C₁₋₆ alkyl or C₂₋₆ alkenyl, monoglycerol or diglycerol, C₄₋₆ polyol or glycol esters of a vegetable oil fatty acid. The compositions include latex coating compositions comprising the epoxidized esters; epoxy resin compositions comprising the epoxidized esters; thermoset plastic compositions comprising the epoxidized esters; and PVC compositions comprising the epoxidized esters. The invention is directed to epoxidized monoglycerides or diglycerides, and expoxidized C₄₋₆ polyol esters of vegetable oil fatty acids.

### BRIEF DESCRIPTION OF THE FIGURES

FIG. 1 depicts several epoxidized vegetable fatty acid esters, including an ester of an epoxidized C₂₋₆ alkenyl moiety, suitable for use in the present invention.

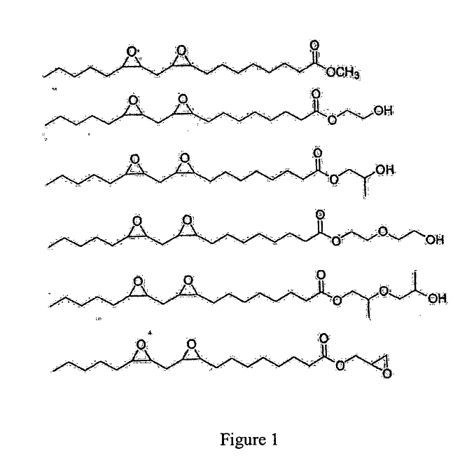

FIG. 2 depicts several epoxidized vegetable fatty acid esters.

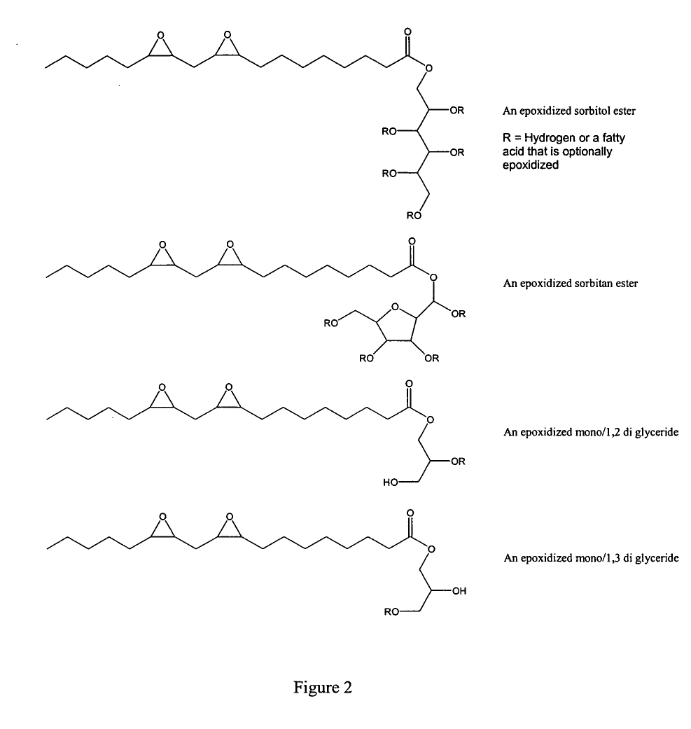

FIG. 3 depicts several epoxidized vegetable fatty acid esters.

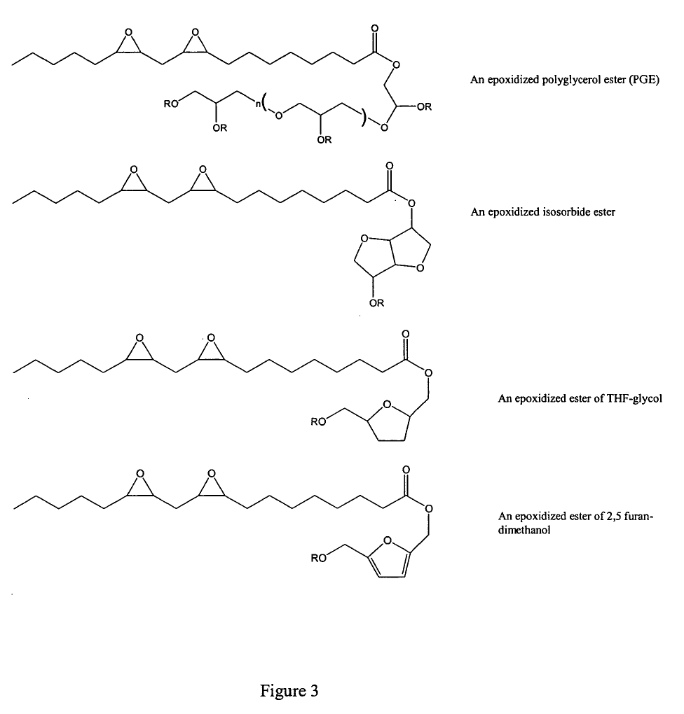

### DETAILED DESCRIPTION OF THE INVENTION

In one aspect, the present invention is directed to a coating composition comprising a latex resin and a C₁₋₆ alkyl or C₂₋₆ alkenyl, monoglycerol or diglycerol, C₄₋₆ polyol or glycol ester of a vegetable oil fatty acid, wherein the ester has at least one oxirane ring formed between two adjacent carbons in the carbon chain of the fatty acid. Vegetable fatty acid esters containing embedded oxirane rings are also referred to as epoxidized vegetable fatty acid esters.

Suitable epoxidized esters of vegetable oil fatty acids include monoesters and diesters of vegetable oil fatty acids. Preferred esters for coating compositions are glycol mono or di esters, C₁₋₆alkyl or C₂₋₆ alkenyl esters, monoglycerides and diglycerides, and C₄₋₆ polyol esters of vegetable oil fatty acids. Methods for preparing suitable esters are well known in the art.

Examples of preferred glycols from which a suitable ester can be derived include, but are not limited to, propylene glycol, dipropylene glycol, ethylene glycol and diethylene glycol.

Examples of preferred C₁₋₆ alkyl esters of epoxidized vegetable oil fatty acids include methyl, ethyl, propyl or butyl esters.

Preferred C₂₋₆ alkenyl esters include allylic and vinylic esters of epoxidized vegetable oil fatty acids. The double bond present in these groups can optionally also be epoxidized in the final product.

Also preferred are monoglycerides and diglycerides of epoxidized vegetable oil fatty acids.

Examples of preferred C₄₋₆ polyols from which a suitable ester can be prepared include simple carbohydrates such as monosaccharides. Preferred C₄₋₆ polyols can be esterified as described herein. More preferred esters of this type will contain the C₄₋₆ residual moiety exemplified in structures A-F below. Preferred monosaccharides include both pyranose and furanose compounds. More preferably, the C₄₋₆ polyol is a sorbitol ester of an epoxidized vegetable oil fatty acid. Also preferred are isosorbide, sorbitan, and sorbitol isosorbide esters of epoxidized vegetable oil fatty acid. These esters will contain the residual C₄₋₆ polyol depicted respectively as structures A, B and C below.

Vegetable oil fatty acids are derived from vegetable oils. Preferred vegetable oils include, but are not limited to, soybean oil, linseed oil, sunflower oil, castor oil, corn oil, canola oil, rapeseed oil, palm kernel oil, cottonseed oil, peanut oil, coconut oil, palm oil, tung oil, safflower oil and derivatives, conjugated derivatives, genetically-modified derivatives and mixtures thereof. As used herein, a reference to a vegetable oil includes all its derivatives as outlined above. For instance, the use of the term “linseed oil” includes all derivatives including conjugated linseed oil. The vegetable oils can be saturated or unsaturated.

Fatty acids derived from vegetable oils include fatty acids containing carbon chains of about 2 to about 24 carbons. More preferably, the carbon chain contains about 12 to about 24 carbons. Most preferably, the number of carbons is about 16 to about 18. Preferably, the fatty acid is unsaturated. The sites of unsaturation can be epoxidized by methods that are known in the art. In the present invention, the fatty acid chains can have one or more oxirane rings. Thus, a fatty acid that has multiple sites of unsaturation can be epoxidized to a greater extent. However, not all double bonds of the fatty acid chain must be epoxidized. A fatty acid chain containing one oxirane ring formed between two adjacent carbons of the carbon chain is a fatty acid from which a suitable ester can be derived. Fatty acids with multiple sites of unsaturation can have one or more double bonds so long as at least one oxirane ring is embedded in adjacent carbons as described above. In a most preferred embodiment, the fatty acid chain will have no more than two sites of unsaturation. Preferred fatty acids include, but are not limited to, palmitoleic acid, oleic acid, linoleic acid, linolenic acid, eleostearic acid, ricinoleic acid, arachidonic acid, cetoleic acid or erucic acid.

Because in the most preferred embodiment there will be no more than two sites of unsaturation in the fatty acid chain, the amount of linolenic acid residue will be minimal. The epoxidation process results in a fatty acid residue wherein the sites of unsaturation are annulated to form oxirane rings, leaving at most two sites of unsaturation in the most preferred embodiment.

When the ester is a C₂₋₆ alkenyl ester of a vegetable oil fatty acid, the alkenyl moiety provides a double bond site suitable for epoxidation. Thus, a suitable alkenyl ester will contain at least one oxirane ring formed between adjacent carbons in the carbon chain of the fatty acid portion, and optionally can contain an oxirane ring in the alkenyl moiety. As described above, alkenyl moieties are preferably allylic and vinylic forms of epoxidized vegetable fatty acid esters.

Any latex resin suitable as a component in a coating composition can be used in the present invention. Such latex resins are commercially available and well known in the art. Suitable latex resins include but are not limited to, styrene-acrylic, styrenics, vinyl-acrylic, styrene-butadiene, vinyl acetate, vinyl versatate and the like.

For coating compositions, suitable types of esters, and vegetable oil and fatty acid raw materials, and the like are as described above.

In coating compositions, it is more preferable that the ester is a propylene glycol monoester, methyl ester or allyl ester of a vegetable oil fatty acid.

In coating compositions, it is more preferable that the vegetable oil is soy, sunflower, corn or linseed oil. Most preferably, the vegetable oil is soy oil.

In coating compositions, the epoxidized vegetable ester as described herein can be present in any amount that results in a final coating composition having the desired rheologic properties as described herein. The amount of epoxidized ester will vary according to the specific type of latex resin blended with the ester. In many useful compositions the amount of ester relative to latex resin will not exceed 70 percent by weight of the resin. Preferably, the epoxidized vegetable ester is present in an amount between about 1 percent and about 70 percent by weight of the latex resin. Preferably, the vegetable ester is present in an amount between about 5 percent and about 40 percent. Most preferably, the vegetable ester is present in an amount between about 10 percent and about 20 percent.

The present invention is also directed to a method of preparing a coating composition comprising combining a latex resin and a C₁₋₆ alkyl or C₂₋₆ alkenyl, monoglycerol or diglycerol, C₄₋₆ polyol or glycol ester of a vegetable oil fatty acid, wherein the ester has at least one oxirane ring formed between two adjacent carbons in the carbon chain of the fatty acid, wherein a coating composition is prepared.

In another aspect, the present invention is directed to an epoxy resin composition comprising an epoxy resin and a C₁₋₆ alkyl or C₂₋₆ alkenyl, monoglycerol or diglycerol, C₄₋₆ polyol or glycol ester of a vegetable oil fatty acid, wherein the ester has at least one oxirane ring formed between two adjacent carbons in the carbon chain of the fatty acid.

Any epoxy resin suitable as a component in an epoxy resin composition can be used in the present invention. Such epoxy resins are commercially available and well known in the art. Suitable epoxy resins include, but are not limited to, Bisphenol A and F, Novolac, epoxy acrylate, epoxy vinyl ester resins, glycol epoxy and brominated epoxy resins.

In this aspect of the present invention, suitable epoxidized esters of vegetable oil fatty acids include monoesters and diesters of vegetable oil fatty acids. In epoxy resin compositions, preferred esters are glycol monoesters, C₁₋₆ alkyl esters and allyl esters of vegetable oil fatty acids. Examples of suitable glycols from which an ester can be derived are as described above. In epoxy resin compositions, it is more preferable that the ester is a propylene glycol monoester, methyl ester or allyl ester of a vegetable oil fatty acid. Most preferably, the ester is a propylene glycol monoester.

Vegetable oil fatty acids are derived from vegetable oils. Preferred vegetable oils are as described above. In epoxy resin compositions, it is more preferable that the vegetable oil is soy, corn, sunflower or linseed oil. Most preferably, the vegetable oil is linseed oil. In a most preferred embodiment, the ester is an epoxidized propylene glycol monoester or allyl ester derived from a fatty acid of linseed oil.

Preferred fatty acids include those recited above. For epoxy resin compositions, oleic acid is more preferred.

When the ester is a C₂₋₆ alkenyl ester of a vegetable oil fatty acid, the alkenyl moiety provides a double bond site suitable for epoxidation. Thus, a suitable C₂₋₆ alkenyl ester will contain at least one oxirane ring formed between adjacent carbons in the carbon chain of the fatty acid portion, and optionally can contain an oxirane ring in the alkenyl moiety. In a most preferred embodiment for epoxy resin compositions, the ester is an epoxidized allyl ester of oleic acid.

In epoxy resin compositions, the vegetable ester as described herein is present in an amount between about 1 percent and about 70 percent by weight of the epoxy resin. Preferably, the vegetable ester is present in an amount between about 5 percent and about 40 percent. Most preferably, the vegetable ester is present in an amount between about 10 percent and about 20 percent.

The present invention is also directed to a method of preparing the epoxy resin composition described above comprising combining an epoxy resin and a C₁₋₆ alkyl or C₂₋₆ alkenyl, monoglycerol or diglycerol, C₄₋₆ polyol or glycol ester of a vegetable oil fatty acid, wherein the ester has at least one oxirane ring formed between two adjacent carbons in the carbon chain of the fatty acid, wherein an epoxy resin composition is prepared.

In another aspect, the present invention is directed to a thermoset plastic composition comprising an epoxy resin composition as described herein and an amine. The one or more oxirane rings contained in the fatty acid portions of the ester component of the composition can react with an amine to form a urethane. Any amine capable of combining with an oxirane to form a urethane linkage is a suitable amine. Preferably, the amine is a diamine or triamine that is capable of reacting with multiple oxirane moieties thereby creating a crosslinked urethane thermoset plastic upon curing. Preferred amines include aliphatic and aromatic amines which may or may not contain two or more primary or secondary amines. Additional examples include, but are not limited to, ethylene diamine, methylene dianiline diethylene triamine, polyamides, imidazoles and anhydrides such as pyromellitic acid dianhydride.

The present invention is also directed to a method of preparing a thermoset plastic comprising combining: (a) an epoxy resin comprising a C₁₋₆ alkyl or C₂₋₆ alkenyl, monoglycerol or diglycerol, C₄₋₆ polyol or glycol ester of a vegetable oil fatty acid, wherein the ester has at least one oxirane ring formed between two adjacent carbons in the carbon chain of the fatty acid, and (b) an amine. Preferably, the amine is a diamine or triamine that is capable of reacting with multiple oxirane moieties thereby creating a crosslinked urethane thermoset plastic upon curing. Any amine capable of combining with an oxirane to form a urethane linkage is a suitable amine. Preferred amines include those listed above.

In another aspect, the present invention is directed to a polymer composition comprising polyvinyl chloride (PVC) and a C₁₋₆ alkyl or C₂₋₆ alkenyl, C₄₋₆ polyol or glycol ester of a vegetable oil fatty acid, wherein the ester has at least one oxirane ring formed between two adjacent carbons in the carbon chain of the fatty acid.

In this aspect of the present invention, suitable epoxidized esters of vegetable oil fatty acids include monoesters and polyol esters of vegetable oil fatty acids. In PVC polymer compositions, preferred esters are glycol monoesters, C₄₋₆ polyol esters and allyl esters of vegetable oil fatty acids.

Examples of suitable glycols from which an ester can be derived are as described above. In PVC polymer compositions, it is more preferable that the ester is a propylene glycol monoester. Other preferred esters for use in PVC compositions will contain the C₄₋₆ residual moiety exemplified in structures A-F below. Structures A-E are also commonly called isosorbide, sorbitan, tetrahydrofuran dimethanol, furan dimethanol, and sorbitol respectively.

Vegetable oil fatty acids are derived from vegetable oils. Preferred vegetable oils are as described above. In PVC polymer compositions, it is more preferable that the vegetable oil is soy, sunflower, corn or linseed oil. Most preferably, the vegetable oil is soy oil. In a most preferred embodiment, the ester is an epoxidized propylene glycol monoester of a fatty acid derived from soy oil.

Vegetable oil fatty acids are as described above.

The present invention is also directed to a method of preparing a polymer composition comprising combining polyvinyl chloride and a C₁₋₆ alkyl or C₂₋₆ alkenyl, C₄₋₆ polyol or glycol ester of a vegetable oil fatty acid, wherein the ester has at least one oxirane ring formed between two adjacent carbons in the carbon chain of said fatty acid.

In PVC polymer compositions, the vegetable ester as described herein is present in an amount between about 1 percent and about 70 percent by weight of the polymer. Preferably, the vegetable ester is present in an amount between about 5 percent and about 40 percent. Most preferably, the vegetable ester is present in an amount between about 10 percent and about 20 percent.

The present invention is also directed to monoglycerides, diglycerides, and C₄₋₆ polyol esters of epoxidized vegetable oil fatty acids. Such compounds include monoglycerides and diglycerides of the vegetable oil fatty acids described herein, wherein at least one oxirane ring is formed between two adjacent carbons in the carbon chain of the fatty acid. A diglyceride can be a 1,2 diglyceride or a 1,3 diglyceride.

The compounds of the present invention include esters formed by esterification of monosaccharides and vegetable oil fatty acids wherein at least one oxirane ring is formed between two adjacent carbons in the carbon chain of the fatty acid. In this embodiment, preferred compounds include epoxidized sorbitol esters of vegetable oil fatty acids, and derivatives thereof. Also included in the compounds of the present invention are epoxidized sorbitan esters and isosorbide esters.

The C₄₋₆ polyol esters can be derived from any C₄₋₆ polyol and include cyclic and bicyclic polyols. Preferred cyclic structures include furan and pyran derivatives. Many suitable C₄₋₆ polyols are carbohydrates. A preferred polyol is sorbitol. A preferred bicyclic polyol is isosorbide.

The fatty acid chain contains at least at least one oxirane ring is formed between two adjacent carbons. The fatty acid chain may also contain one or more double bonds. Thus, the present invention is directed to a partially epoxidized ester of a vegetable oil fatty acid. Such double bonds can be conjugated or unconjugated. The fatty acid chain can also be further substituted. In this embodiment, the carbons of the carbon chain are independently substituted with one or more substituents selected from the group consisting of hydrogen, hydroxy(C₁₋₁₀)alkyl, amino(C₁₋₁₀)alkyl, C₁₋₁₀ alkyl, C₁₋₁₀ alkoxy, C₆₋₁₀ aryl, hydroxy, heteroaryl, C₃₋₆ cycloalkyl and phenyl(C₁₋₄)alkyl. Preferably, the carbons are derivatized to contain substituents that modify the chain's physical and chemical properties in its end use application. Such modifications include those that affect surfactant properties, pour point, viscosity, crystallization, polymerization and the like. Preferably, substituents added for the above purposes include esters, alcohols, amides, amines, ketones, epoxides, carboxylic acids, alkenes, alkynes, azides, hydrazides, imines, oximes, etc. More preferred substituents will be aliphatic alcohols (branched or straight chain) and aliphatic amines. The addition of these aliphatic groups can disrupt chain packing to prevent crystallization.

Compounds of the present invention include compounds of the formula: 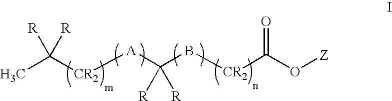
wherein,
A and B are selected from the group consisting of:
   —(CR₂)—, —(CR═CR)— and 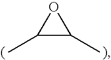
      wherein at least one of A or B is 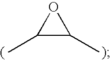
R in each instance is independently selected from the group consisting of: hydrogen, hydroxy(C₁₋₁₀)alkyl, amino(C₁₋₁₀)alkyl, C₁₋₁₀ alkyl, C₁₋₁₀ alkoxy, C₆₋₁₀ aryl, hydroxy, heteroaryl, C₃₋₆ cycloalkyl and phenyl(C₁₋₁₀)alkyl;
m is an integer between about 2 and about 10;
n is an integer between about 2 and about 10; and
Z is selected from the group consisting of: 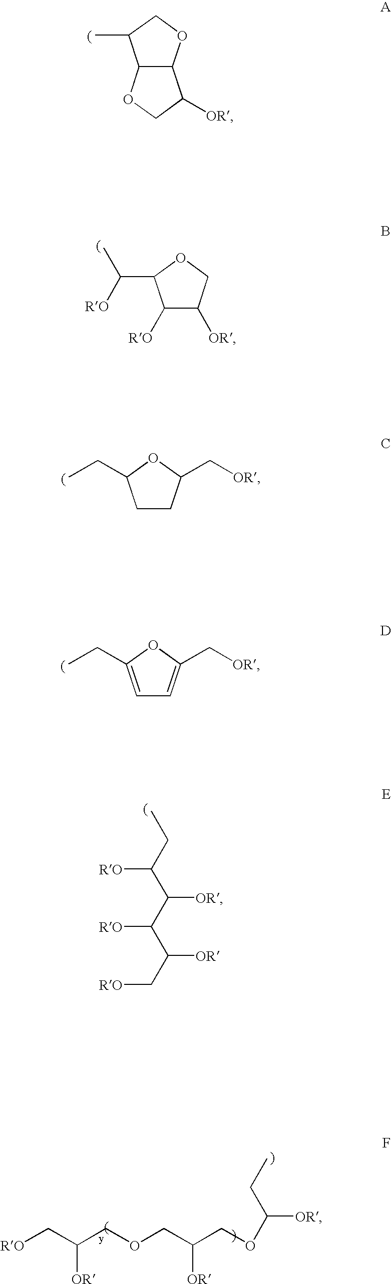
   wherein, y is an integer between about 2 and about 50, and 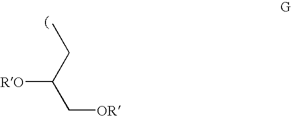
   wherein, R′ is in each instance independently selected from the group consisting of hydrogen, carboxyallylic, carboxy(C₁₋₅)alkyl, C₁₋₅ alkyl and 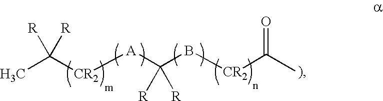
      wherein R, A, B, m and n are as described above.

Useful compounds include those compounds where A and B are described above. In all embodiments, at least one of A or B is an oxirane ring embedded in the carbon chain. In partially epoxidized esters, one of A or B can be —(CR═CR)— or —CR₂—.

Useful compounds include those compounds where R is as described above. Preferred compounds include those compounds where R in each instance is independently hydrogen, hydroxy(C₁₋₁₀)alkyl, or amino(C₁₋₁₀)alkyl. In all embodiments, R in each instance is independently selected from other instances of R on the same molecule.

Useful values of m and n are described above. In preferred embodiments, m is an integer between about 2 and about 5. Preferred values for n include integers between about 4 and about 7.

Useful compounds are those where Z is defined as above. When Z is 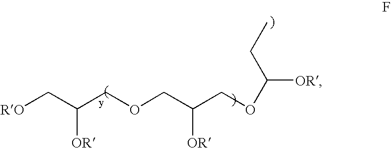
y is determined by the size of the PGE (polyglycerol ester) used. PGEs are well known in the art. Examples of useful PGEs include decaglycerol monooleate, decaglycerol decaoleate, decaglycerol monostearate, triglycerol monooleate, triglycerol monostearate, and the like. Thus, useful values of y include are integers between about 2 and about 50. Preferably, the value of y is between about 2 and about 30. More preferably, the value of y is between about 2 and about 20. The value of y is based on the size of the polymer. Thus, it is intended only to identify the PGE that can be incorporated into the compound, and is not a precise value for the number of monomers in the PGE.

When Z is 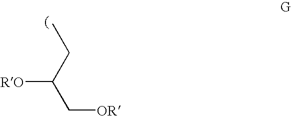
only one of R′ can be a fatty acid moiety as depicted above as structure α. The other of R′ is hydrogen, carboxyallylic, carboxy(C₁₋₅)alkyl or C₁₋₅ alkyl, which is not a fatty acid.

In all preferred embodiments, R′ is hydrogen regardless of the value of Z. In all embodiments, R′ in each instance is independently selected from other instances of R′ on the same molecule.

The present invention is also directed to a method of lowering the T_{g} of a polymer composition by adding an effective amount of a compound described above to the polymer composition. The T_{g} of the composition comprising the compound will be lower than the T_{g} of the composition as measured prior to adding the compound. An “effective amount” is any amount capable of lowering the T_{g} by not less than about 2° C. Preferably, the method of lowering the T_{g} of a polymer composition comprises adding a compound such that the T_{g} is lowered by not less than about 5° C. More preferably, the T_{g} is lowered by not less than about 10° C. The compounds described above may function as plasticizers before reacting with the polymer to become part of the polymer matrix. Particularly, in the case of PVC polymers, the compounds behave as plasticizers and do not appreciably react with the polymer.

The compounds are also useful as stabilizers. The compounds are capable of scavenging H⁺ ions that may form in the polymer over time. This is particularly useful in PVC compositions. The amount of compound necessary to stabilize a composition can be less than that required to lower the T_{g} by not less than about 2° C. Any amount of compound present can act to neutralize H⁺ thereby providing a stabilizing effect.

As described herein, “alkenyl” represents any branched or unbranched, substituted or unsubstituted carbon chain containing at least one site of unsaturation. An example is an “allyl” ester, which is an ester of a vegetable oil fatty acid formed by esterification of a fatty acid with allyl alcohol or transesterification of an oleate with allyl alcohol.

The term “alkyl” as employed herein by itself or as part of another group refers to both straight and branched chain radicals of up to 10 carbons, preferably 6 carbons, more preferably 4 carbons, such as methyl, ethyl, propyl, isopropyl, butyl, t-butyl, and isobutyl.

The term “alkoxy” is used herein to mean a straight or branched chain alkyl radical, as defined above, unless the chain length is limited thereto, bonded to an oxygen atom, including, but not limited to, methoxy, ethoxy, n-propoxy, isopropoxy, and the like. Preferably the alkoxy chain is 1 to 10 carbon atoms in length, more preferably 1-4 carbon atoms in length.

The term “aryl” as used herein by itself or as part of another group refers to monocyclic or bicyclic aromatic groups containing from 6 to 12 carbons in the ring portion, preferably 6-10 carbons in the ring portion, such as the carbocyclic groups phenyl, naphthyl or tetrahydronaphthyl. The term “aryl” can represent carbocyclic aryl groups, such as phenyl, naphthyl or tetrahydronaphthyl, as well as heterocyclic aryl (“heteroaryl”) groups, such as pyridyl, pyrimidinyl, pyridazinyl, furyl, and pyranyl.

The term “heteroaryl” as used herein refers to groups having 5 to 14 ring atoms; 6, 10 or 14 π-electrons shared in a cyclic array; and containing carbon atoms and 1, 2 or 3 oxygen, nitrogen or sulfur heteroatoms. Examples of heteroaryl groups include thienyl, imadizolyl, oxadiazolyl, isoxazolyl, triazolyl, pyridyl, pyrimidinyl, pyridazinyl, furyl, pyranyl, thianthrenyl, pyrazolyl, pyrazinyl, indolizinyl, isoindolyl, isobenzofuranyl, benzoxazolyl, xanthenyl, 2H-pyrrolyl, pyrrolyl, 3H-indolyl, indolyl, indazolyl, purinyl, 4H-quinolizinyl, isoquinolyl, quinolyl, phthalazinyl, naphthyridinyl, quinazolinyl, phenanthridinyl, acridinyl, perimidinyl, phenanthrolinyl, phenazinyl, isothiazolyl, phenothiazinyl, isoxazolyl, furazanyl, and phenoxazinyl groups. Especially preferred heteroaryl groups include 1,2,3-triazole, 1,2,4-triazole, 5-amino-1,2,4-triazole, imidazole, oxazole, isoxazole, 1,2,3-oxadiazole, 1,2,4-oxadiazole, 3-amino-1,2,4-oxadiazole, 1,2,5-oxadiazole, 1,3,4-oxadiazole, pyridine, and 2-aminopyridine.

The term “cycloalkyl” as used herein by itself or as part of another group refers to cycloalkyl groups containing 3 to 9 carbon atoms, more preferably, 3 to 8 carbon atoms. Typical examples are cyclopropyl, cyclobutyl, cyclopentyl, cyclohexyl, cycloheptyl, cyclooctyl and cyclononyl.

The term “phenyl(C₁₋₄)alkyl” as used herein refers to C₁₋₄ alkyl groups as referred to above having an phenyl substituent and includes benzyl.

The term “carboxy” as used herein describes a carbon double bonded to an oxygen. The carbon may be additionally substituted.

The term “carboxyallylic” as used herein describes a carbon double bonded to an oxygen wherein the carbon is further substituted with an allylic group.

The term “carboxy(C₁₋₅)alkyl” as used herein describes a carbon double bonded to an oxygen wherein the carbon is further substituted with a C₁₋₅ alkyl group.

It is understood that the present invention encompasses the use of stereoisomers, diastereomers and optical isomers.

When any variable occurs more than one time in any constituent its definition on each occurrence is independent of its definition at every other occurrence. Also, combinations of substituents and/or variables are permissible only if such combinations result in stable compounds.

This disclosure describes the epoxidation of certain vegetable oil esters, and uses thereof. The resulting epoxidized vegetable esters as described herein can be used, among other things, as coalescing aids in latex paints, reactive diluents in epoxy resin formulations and as plasticizers for polymers. The added epoxide functionality can replace the carbon-carbon double bonds in the fatty acid chains. However, one or more double bonds can still be present in the chain. Further, the functions of epoxidized vegetable esters in compositions described herein are not limited to the functions explicitly described.

The following schemes depict a synthetic route for preparing epoxidized fatty acid derivatives.

Scheme 1 depicts a general reaction scheme for synthesis of epoxidized fatty acid derivatives. Fatty acids of alkyl esters, preferably methyl or ethyl, can be prepared by an esterification or transesterification reaction between an ester, alcohol or polyol. Esterification/transesterification can be catalyzed by lipase enzymes. Following the ester synthesis, the C═C bonds are epoxidized using an oxidant such as hydrogen peroxide. The chemical pathway usually employs formic acid or the combination of acetic acid and a strong mineral acid. Enzymes capable of facilitating epoxidation include lipase from Candida antartica such as Novozyme 435 (Novozymes). (Klass, M. R. and Warwel, S. “Chapter 10. New Oxidation Methods for Unsaturated Fatty Acids, Esters and Triglycerides.” in Recent Developments in the Synthesis of Fatty Acid Derivatives, G. Knothe and J. Derksen, eds. AOCS Press, Champaign Ill., 1999.) If lipase is used, the process has the potential to operate in a one-pot synthesis.

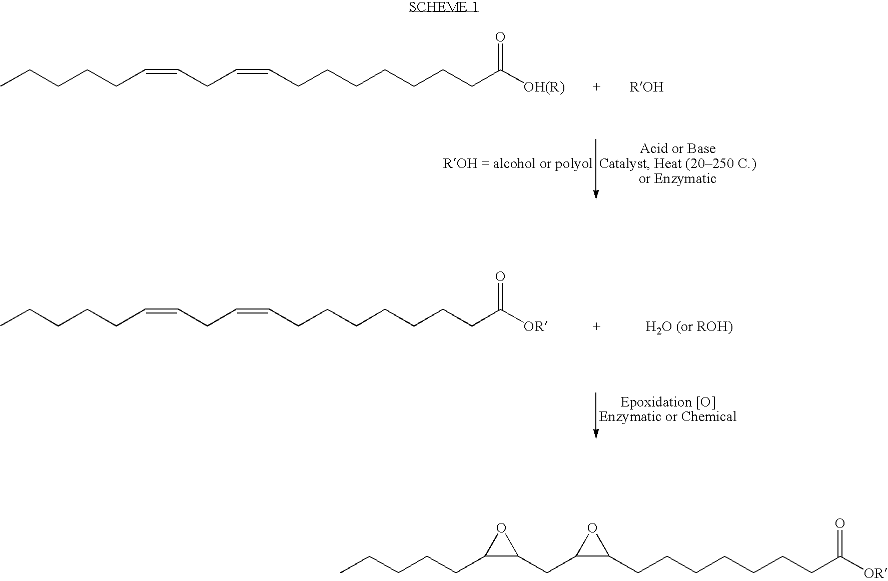

Scheme 2 depicts a synthetic route for preparing dianhydrohexitol (isosorbide) esters of epoxidized fatty acid derivatives.

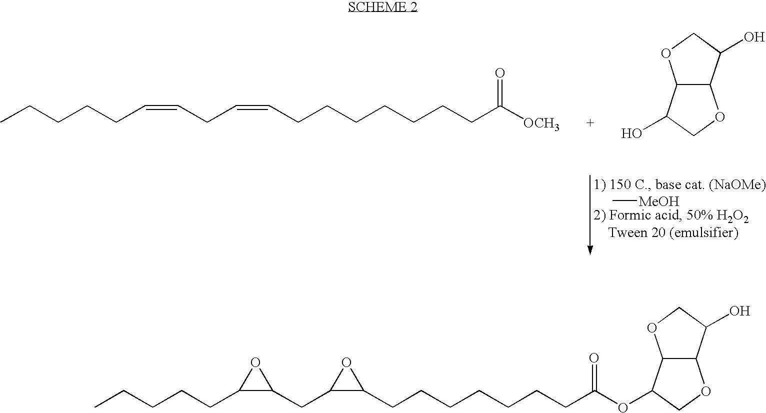

Scheme 3 depicts a synthetic route for preparing a PGE ester of an epoxidized fatty acid derivative.

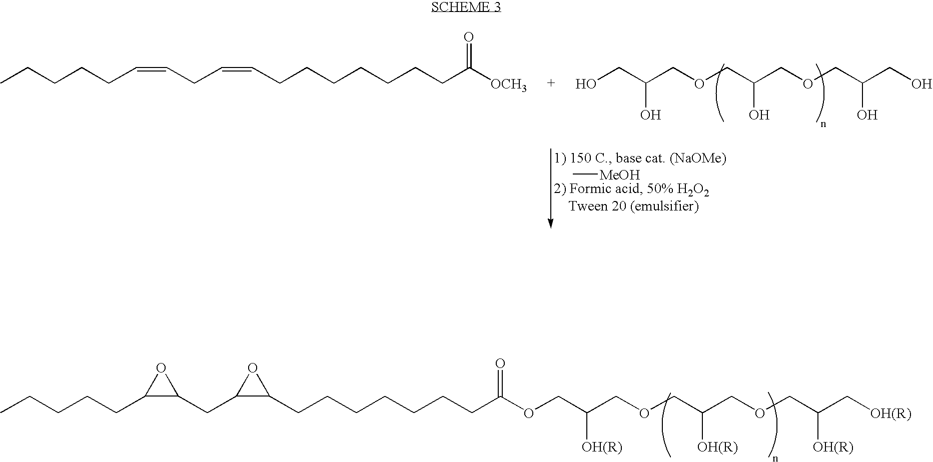

Scheme 4 depicts a synthetic route for preparing a THF-glycol ester of an epoxidized fatty acid ester derivative.

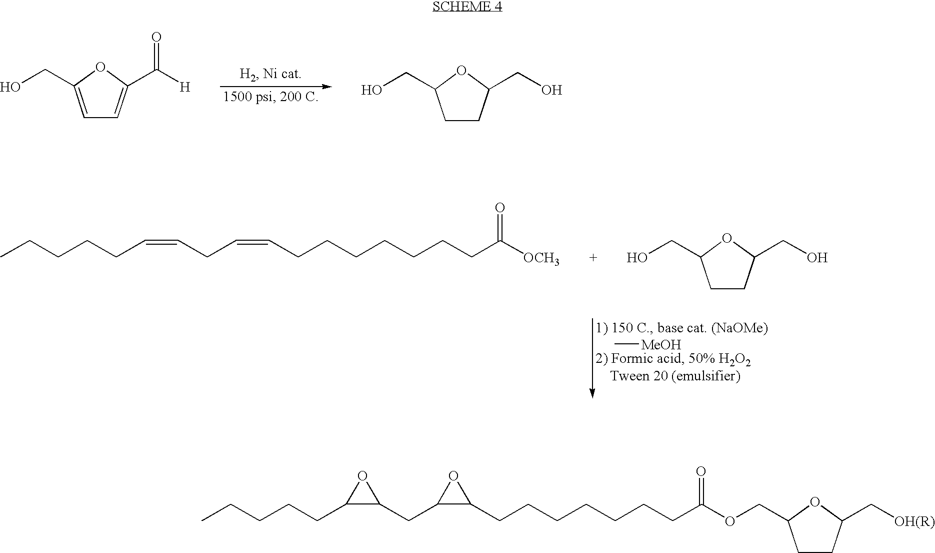

Scheme 5 depicts a synthetic route for preparing a furandimethanol ester of an epoxidized fatty acid ester derivative.

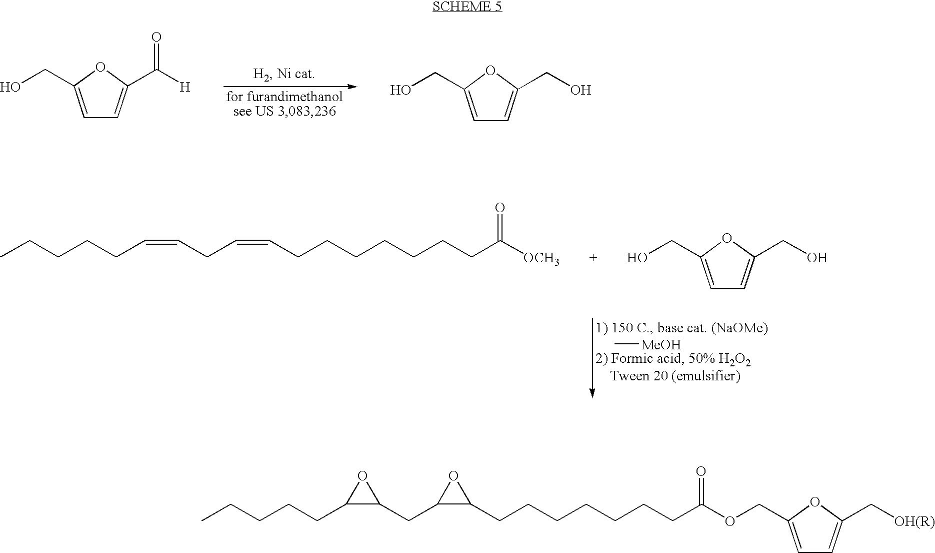

Double bonds in the fatty acid chains are known to be reactive sites for oxidation and tend to contribute to yellowing of a dried film over time. Epoxide groups will not undergo the same air oxidation as double bonds. Thus, a reduction in the number of double bonds can diminish yellowing.

In addition, epoxide groups will react with amines and other cure agents typically used in epoxy resin formulations. Therefore, epoxidized vegetable esters as described herein can be used as reactive diluent/resin modifiers in epoxy formulations.

Epoxidized vegetable esters as described herein can be incorporated in plastics to modify polymer properties, such as a reduction of the glass transition temperature. The epoxide group is a reactive site in a polymeric system. Thus, incorporating the epoxides into the coatings and polymers described herein can impact characteristics such as flexibility, hardness, solvent resistance, melt-viscosity, cure rate and gel point. Further, in PVC polymers, epoxides act as stabilizers by scavenging HCl which is liberated during PVC decomposition.

### EXAMPLES

### Example 1

### Epoxidized Propylene Glycol Monoester of Soybean Oil Fatty Acids

Distilled soy PGME (150 g) was added to a round bottom flask along with aqueous hydrogen peroxide (100 mL, 50%), formic acid (10 mL, 98%) and Tween 20 (0.1 g). The mixture was stirred vigorously at room temperature for 24 hours. The reaction mixture was extracted in a separatory funnel with hexanes/ethyl acetate and washed with an aqueous sodium sulfite solution. The organic layer was washed several more times with deionized water and then dried over magnesium sulfate (anhydrous), filtered and then solvents were removed using a rotary evaporator. The resulting epoxidized PGME was a colorless liquid at room temperature. NMR analysis of the epoxidized PGME confirmed that olefinic proton signals (˜5.2-5.4 ppm) were reduced and were replaced by new oxirane proton signals (2.8-3.0 ppm).

### Example 2

### Epoxidized PGME as Reactive Diluent in Epoxy Resin

35 grams of Bisphenol epoxy resin (D.E.R. 331, Dow Chemical) was mixed with 20 grams of epoxidized propylene glycol monoesters of linseed oil. The mixture remained clear and a homogeneous solution was produced. The mixture had a viscosity of 580cP (Brookfield, #4 spindle, 30 RPM at 22.5° C.). The initial epoxy resin had a viscosity of 16300 cP at 22.5° C.

### Example 3

### Synthesis of Epoxidized Allyl Oleate

The epoxidation of allyl oleate (30 g) was performed as described in Example 1.

### Example 4

### Epoxidized Allyl Oleate as Reactive Diluent in Epoxy Resin

Epoxidized allyl oleate was blended with DER331 resin (Dow Chemical) at 10% and 20%. The viscosity of the neat resin and two blends was determined with a Brookfield viscometer (#4 spindle, 30 RPM, 22.5° C.).

| Sample | Epoxidized Allyl Oleate (wt %) | Viscosity (cP) |
|---|---|---|
| 1 | -0- | 16300 |
| 2 | 10 | 2320 |
| 3 | 20 | 660 |

### Example 5

### Synthesis of Epoxidized Allyl Oleate—Epoxy Resin Thermoset Plastic

Bisphenol A diglycide ether resin (DER331, Dow Chemical), diethylene triamine (DETA) and epoxidized allyl oleate were combined to form an epoxy thermoset plastic. The epoxide equivalent weight (EEW) of DER331 was 185.4. The EEW of epoxidized allyl oleate was determined to be 177.26 ([354.52 g/mol Epoxidized Allyl Oleate)/(2 mol epoxide functionality per molecule)]=177.26). The amine equivalent of DETA was 20.6. The EEW of a 20% Epoxy allyl oleate (EAO) mixture with DER331 (total weight of 60 g) was calculated as follows: EEWₘᵢₓ=60 g mix/[12 g EAO/177.26)+(48b DER331/185.4)]=183.7.

The amount of DETA added:

Amine Equivalent=20.6.
phr amine=(20.6×100)/183.7=11.2 parts amine per 100 parts mix.
   A final thermoset plastic was produced by mixing 50 g of the EAO/DER331 mixture with 5.6 grams of DETA. The mixture was mixed thoroughly in a plastic hexagonal weighing boat and allowed to cure overnight.

### Example 6

### Epoxidized Soya PGME as a Plasticizer for Polyvinyl Chloride (PVC)

A. High molecular weight PVC (10.0 g) and epoxidized soya PGME (7.0 g) was added to a glass jar and mixed well to disperse liquid PGME over the PVC particles. The mixture was allowed to sit for 2 hours in a 100° C. oven. The material was a free-flowing powder. A sample of the material was added to a differential scanning calorimeter (DSC) pan. The DSC was scanned from −40° C. to 120° C. A very broad low temperature transition from ˜−10 to 20° C. was recorded during the test. The PVC removed from the DSC pan was a soft, rubbery, clear solid at room temperature. The unplasticized glass transition temperature (Tg) of PVC was 87° C.

B. High molecular weight PVC (10.0 g) and epoxidized soya PGME (1.0 g) was added to a glass jar and mixed well to disperse liquid PGME over the PVC particles. The mixture was allowed to sit for 2 hours in a 100° C. oven. The material was a free-flowing powder. A sample of the material was added to a differential scanning calorimeter (DSC) pan. The DSC was scanned from −40° C. to 120° C. A glass transition temperature of 64.8° C. was recorded during the test. The PVC removed from the DSC pan was a soft, rubbery, clear solid at room temperature. The unplasticized glass transition temperature (Tg) of PVC was 87° C.

### Example 7

### Plasticization of Latex Emulsion Resins

Latex emulsion resins UCAR 379G (vinyl acrylic, Dow Chemical) and SG30 (acrylic, Rohm and Haas) were used as received from the manufacturer. Epoxidized PGME was prepared as described in Example 1 above. Epoxidized PGME was added to UCAR 379G at 12% by weight of latex solids. The samples were mixed thoroughly. After mixing, films were cast of neat UCAR 379G (no added epoxidized PGME) and UCAR 379G containing 12% epoxidized PGME.

The samples were allowed to dry at room temperature for five days. After five days, the glass transition temperature of the films were analyzed by differential scanning calorimetry. UCAR 379G (neat) had a glass transition temperature of 15.6° C. UCAR 379G containing 12% epoxidized PGME had a glass transition temperature of 7.4° C.

The test was repeated using SG30 (neat) and SG30 containing 6% epoxidized PGME. SG30 (neat) had a glass transition temperature of 19.9° C. SG30 containing 6% epoxidized PGME had a glass transition temperature of 6.9° C.

Having now fully described this invention, it will be understood to those of ordinary skill in the art that the same can be performed within a wide and equivalent range of conditions, formulations, and other parameters without affecting the scope of the invention or any embodiment thereof.

What is claimed is:

1. A coating composition comprising, a latex resin and a C₁₋₆ alkyl, C₂₋₆ alkenyl, epoxidized C₂₋₆ alkenyl, monoglycerol, diglycerol, C₄₋₆ polyol or glycol ester of a vegetable oil fatty acid, wherein said ester has at least one oxirane ring formed between two adjacent carbons in the carbon chain of said fatty acid.

2. The coating composition of claim 1, wherein said ester is present in an amount between about 1 percent and about 70 percent by weight of said latex resin.

3. The coating composition of claim 2, wherein said ester is present in an amount between about 5 percent and about 40 percent by weight of said latex resin.

4. The coating composition of claim 3, wherein said ester is present in an amount between about 10 percent and about 20 percent by weight of said latex resin.

5. The coating composition of claim 1, wherein said ester is a glycol monoester.

6. The coating composition of claim 5, wherein said ester is a propylene glycol monoester, dipropylene glycol monoester, ethylene glycol monoester or diethylene glycol monoester.

7. The coating composition of claim 1, wherein said ester is a propylene glycol monoester.

8. The coating composition of claim 1, wherein said ester is a C₁₋₆ alkyl ester.

9. The coating composition of claim 1, wherein said ester is a methyl ester.

10. The coating composition of claim 1, wherein said ester is an allyl ester.

11. The coating composition of claim 1, wherein said ester is derived from an unsaturated vegetable oil fatty acid.

12. The coating composition of claim 11, wherein said unsaturated vegetable oil fatty acid is derived from an unsaturated vegetable oil selected from the group consisting of soybean oil, linseed oil, sunflower oil, castor oil, corn oil, canola oil, rapeseed oil, palm kernel oil, cottonseed oil, peanut oil, coconut oil, palm oil, tung oil, safflower oil and derivatives, conjugated derivatives, genetically-modified derivatives, and mixtures thereof.

13. The coating composition of claim 12, wherein said unsaturated vegetable oil is soy, sunflower corn or linseed oil.

14. The coating composition of claim 13, wherein said unsaturated vegetable oil is soy oil.

15. The coating composition of claim 1, wherein said glycol or C₄₋₆ polyol ester has the following structure: 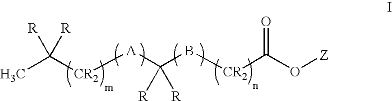
wherein,
A and B are selected from the group consisting of:
—(CR₂)—, —(CR═CR)— and 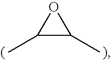
wherein at least one of A or B is 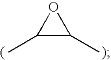
R in each instance is independently selected from the group consisting of: hydrogen, hydroxy(C₁₋₁₀)alkyl, amino(C₁₋₁₀)alkyl, C₁₋₁₀ alkyl, C₁₋₁₀ alkoxy, C₆₋₁₀ aryl, hydroxy, heteroaryl, C₃₋₆ cycloalkyl and phenyl(C₁₋₄)alkyl;
m is an integer between about 2 and about 10;
n is an integer between about 2 and about 10; and
Z is selected from the group consisting of: 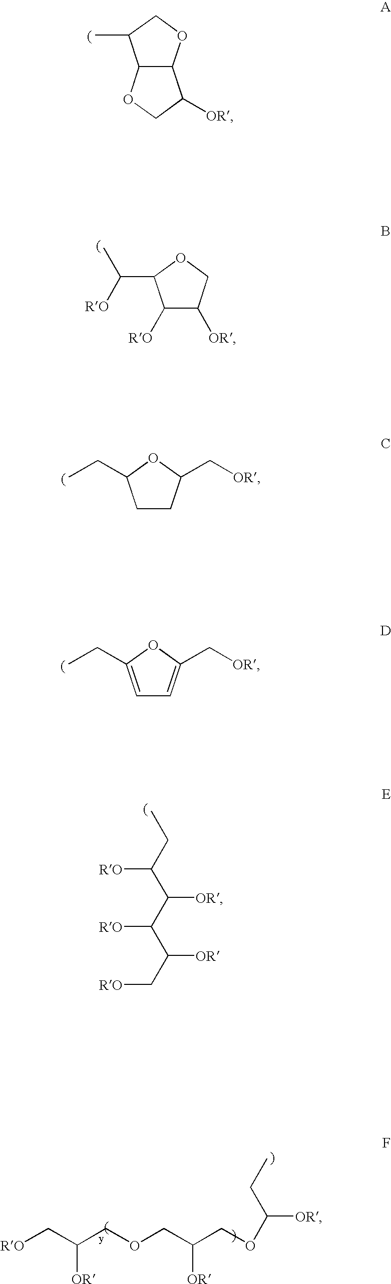
wherein, y is an integer between about 2 and about 50, and 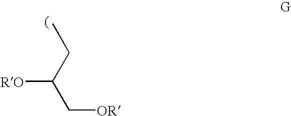
wherein, R′ is in each instance independently selected from the group consisting of hydrogen, carboxyallylic, carboxy(C₁₋₅)alkyl, C₁₋₅ alkyl and 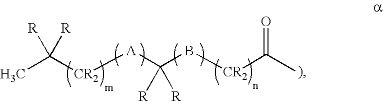
wherein R, A, B, m and n are as described above.

16. A method of preparing the coating composition of claim 1 comprising, combining a latex resin and a C₁₋₆ alkyl, epoxidized C₂₋₆ alkenyl, C₂₋₆ alkenyl, monoglycerol or diglycerol, C₄₋₆ polyol or glycol ester of a vegetable oil fatty acid, wherein said ester has at least one oxirane ring formed between two adjacent carbons in the carbon chain of said fatty acid, wherein a coating composition is prepared.

17. The method of claim 16, wherein said ester is a glycol monoester, C₁₋₆ alkyl ester, sorbitol ester, sorbitan ester, isosorbide ester, furfural alcohol ester or allyl ester.

18. The method of claim 16, wherein said ester is a propylene glycol monoester.

19. The method of claim 16, wherein said ester is derived from an unsaturated vegetable oil fatty acid.

20. The method of claim 16, wherein said ester is a propylene glycol monoester of an unsaturated vegetable oil fatty acid.

21. The method of claim 20, wherein said unsaturated vegetable oil fatty acid is derived from unsaturated soy oil.

22. An epoxy resin composition comprising an epoxy resin and a C₁₋₆ alkyl, C₂₋₆ alkenyl, epoxidized C₂₋₆ alkenyl, monoglycerol, diglycerol, C₄₋₆ polyol or glycol ester of a vegetable oil fatty acid, wherein said ester has at least one oxirane ring formed between two adjacent carbons in the carbon chain of said fatty acid.

23. The epoxy resin composition of claim 22, wherein said ester is present in an amount between about 1 percent and about 70 percent by weight of said epoxy resin.

24. The epoxy resin composition of claim 23, wherein said ester is present in an amount between about 5 percent and about 40 percent by weight of said epoxy resin.

25. The epoxy resin composition of claim 24, wherein said ester is present in an amount between about 10 percent and about 20 percent by weight of said epoxy resin.

26. The epoxy resin composition of claim 22, wherein said ester is a glycol monoester.

27. The epoxy resin composition of claim 26, wherein said ester is a propylene glycol monoester, dipropylene glycol monoester, ethylene glycol monoester or diethylene glycol monoester.

28. The epoxy resin composition of claim 27, wherein said ester is a propylene glycol monoester.

29. The epoxy resin composition of claim 22, wherein said ester is a C₁₋₆ alkyl ester.

30. The epoxy resin composition of claim 22, wherein said ester is a methyl ester.

31. The epoxy resin composition of claim 22, wherein said ester is an allyl ester.

32. The epoxy resin composition of claim 22, wherein said glycol or C₄₋₆ polyol ester has the following structure: 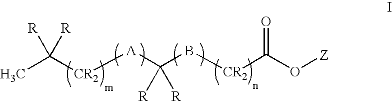
wherein,
A and B are selected from the group consisting of:
—(CR₂)—, —(CR═CR)— and 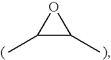
wherein at least one of A or B is 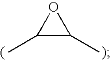
R in each instance is independently selected from the group consisting of: hydrogen, hydroxy(C₁₋₁₀)alkyl, amino(C₁₋₁₀)alkyl, C₁₋₁₀ alkyl, C₁₋₁₀ alkoxy, C₆₋₁₀ aryl, hydroxy, heteroaryl, C₃₋₆ cycloalkyl and phenyl(C₁₋₄)alkyl;
m is an integer between about 2 and about 10;
n is an integer between about 2 and about 10; and
Z is selected from the group consisting of: 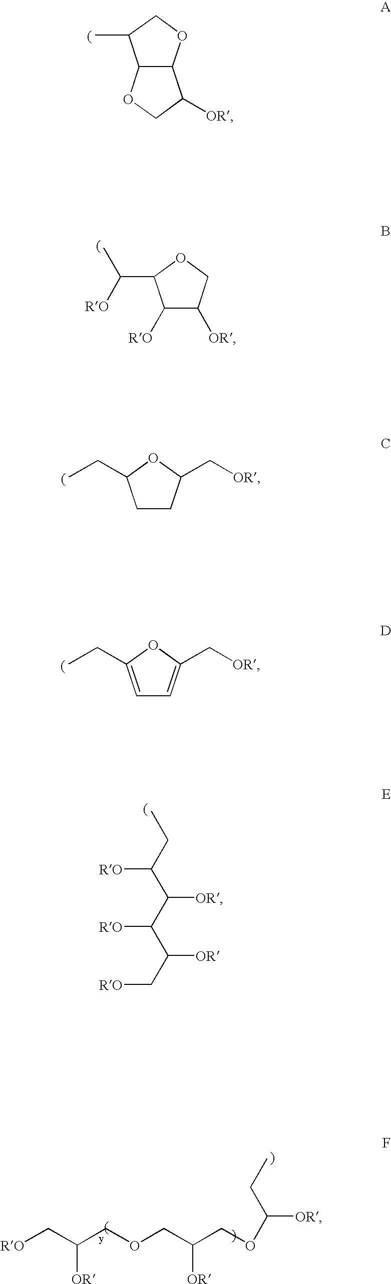
wherein, y is an integer between about 2 and about 50, and 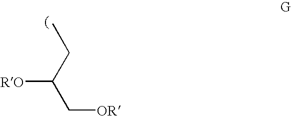
wherein, R′ is in each instance independently selected from the group consisting of hydrogen, carboxyallylic, carboxy(C₁₋₅)alkyl, C₁₋₅ alkyl and 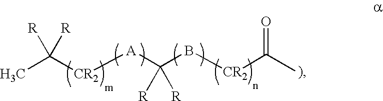
wherein R, A, B, m and n are as described above.

33. The epoxy resin composition of claim 22, wherein said ester is derived from an unsaturated vegetable oil fatty acid.

34. The epoxy resin composition of claim 33, wherein said unsaturated vegetable oil fatty acid is derived from an unsaturated vegetable oil selected from the group consisting of soybean oil, linseed oil, sunflower oil, castor oil, corn oil, canola oil, rapeseed oil, palm kernel oil, cottonseed oil, peanut oil, coconut oil, palm oil, tung oil, safflower oil and derivatives, conjugated derivatives, genetically-modified derivatives, and mixtures thereof.

35. The epoxy resin composition of claim 34, wherein said unsaturated vegetable oil is soy or linseed oil.

36. The epoxy resin composition of claim 35, wherein said unsaturated vegetable oil is linseed oil.

37. The epoxy resin composition of claim 22, wherein said ester is a propylene glycol monoester derived from a fatty acid of linseed oil.

38. The epoxy resin composition of claim 22, wherein said ester is an allyl ester of oleic acid.

39. A method of preparing the epoxy resin composition of claim 22 comprising, combining an epoxy resin and a C₁₋₆ alkyl, C₂₋₆ alkenyl, epoxidized C₂₋₆ alkenyl, monoglycerol, diglycerol, C₄₋₆ polyol or glycol ester of a vegetable oil fatty acid, wherein said ester has at least one oxirane ring formed between two adjacent carbons in the carbon chain of said fatty acid, wherein an epoxy resin composition is prepared.

40. The method of claim 39, wherein said ester is an allyl or propylene glycol mono-ester of a vegetable oil fatty acid.

41. The method of claim 39, wherein said ester is an allyl ester of oleic acid.

42. The method of claim 39, wherein said ester is a propylene glycol monoester of a fatty acid derived from linseed oil.

43. A thermoset plastic composition comprising the epoxy resin composition of claim 22, and an amine.

44. The thermoset plastic composition of claim 43, wherein said amine is selected from the group consisting of aromatic amines, ethylene diamine, methylene dianiline diethylene triamine, polyamides, imidazoles and amine anhydrides.

45. The thermoset plastic composition of claim 43, wherein said amine is diethylene triamine.

46. A method of preparing a thermoset plastic comprising, combining the epoxy resin composition of claim 22, and an amine, wherein a thermoset plastic composition is prepared.

47. A polymer composition comprising polyvinylchloride and a C₂₋₆ alkenyl, epoxidized C₂₋₆ alkenyl, C₄₋₆ polyol, or glycol mono-ester of a vegetable oil fatty acid, wherein said ester has at least one oxirane ring formed between two adjacent carbons in the carbon chain of said fatty acid, and wherein said C₄₋₆ polyol ester has the following structure: 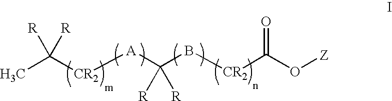
wherein,
A and B are selected from the group consisting of:
—(CR₂)—, —(CR═CR)— and 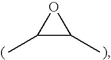
wherein at least one of A or B is 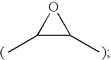
R in each instance is independently selected from the group consisting of: hydrogen, hydroxy(C₁₋₁₀)alkyl, amino(C₁₋₁₀)alkyl, C₁₋₁₀ alkyl, C₁₋₁₀ alkoxy, C₆₋₁₀ aryl, hydroxy, heteroaryl, C₃₋₆ cycloalkyl and phenyl(C₁₋₄)alkyl;
m is an integer between about 2 and about 10;
n is an integer between about 2 and about 10; and
Z is selected from the group consisting of: 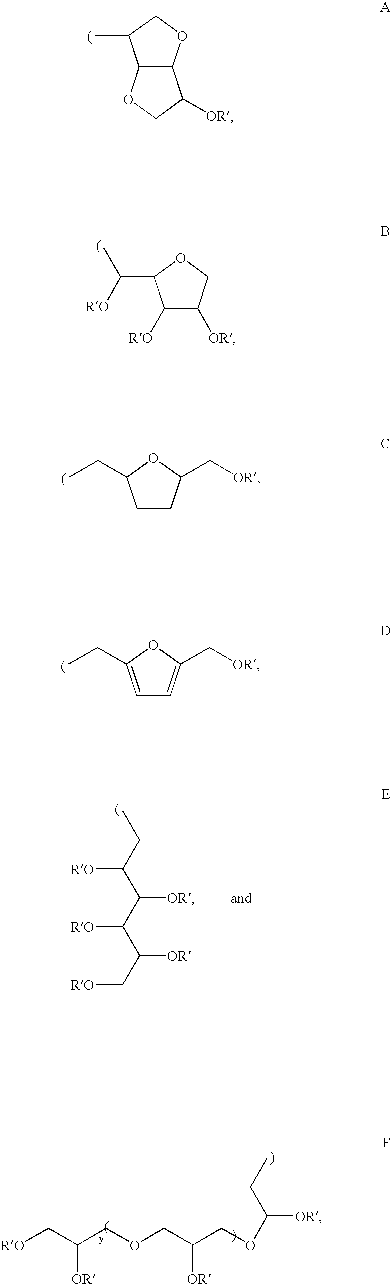
wherein R′ is in each instance independently selected from the group consisting of hydrogen, carboxyallylic, carboxy(C₁₋₅)alkyl, C₁₋₅ alkyl and 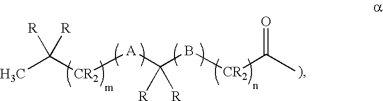
wherein R, A, B, m and n are as described above.

48. The polymer composition of claim 47, wherein said ester is present in an amount between about 1 percent and about 70 percent by weight of said polyvinylchloride.

49. The polymer composition of claim 47, wherein said ester is present in an amount between about 5 percent and about 40 percent by weight of said polyvinylchloride.

50. The polymer composition of claim 47, wherein said ester is present in an amount between about 10 percent and about 20 percent by weight of said polyvinyl chloride.

51. The polymer composition of claim 47, wherein said ester is a glycol monoester.

52. The polymer composition of claim 47, wherein said ester is a propylene glycol monoester, dipropylene glycol monoester, ethylene glycol monoester or diethylene glycol monoester.

53. The polymer composition of claim 47, wherein said ester is a propylene glycol monoester.

54. The polymer composition of claim 47, wherein said ester is an allyl ester.

55. The polymer composition of claim 47, wherein said ester is derived from an unsaturated vegetable oil fatty acid.

56. The polymer composition of claim 47, wherein said unsaturated vegetable oil fatty acid is derived from an unsaturated vegetable oil selected from the group consisting of soybean oil, linseed oil, sunflower oil, castor oil, corn oil, canola oil, rapeseed oil, palm kernel oil, cottonseed oil, peanut oil, coconut oil, palm oil, tung oil, safflower oil and derivatives, genetically-modified derivatives, and mixtures thereof.

57. The polymer composition of claim 47, wherein said unsaturated vegetable oil is soy, corn, sunflower or linseed oil.

58. The polymer composition of claim 57, wherein said unsaturated vegetable oil is soy oil.

59. The polymer composition of claim 47, wherein said ester is a propylene glycol monoester of a fatty acid derived from soy oil.

60. A method of preparing the polymer composition of claim 47 comprising combining polyvinylchloride and said ester of a vegetable oil fatty acid, wherein a polymer composition is prepared.

61. An ester of an epoxidized vegetable oil fatty acid comprising a C₂₋₆ alkenyl, epoxidized C₂₋₆ alkenyl or C₄₋₆ polyol ester of a vegetable oil fatty acid, wherein said ester has at least one oxirane ring formed between two adjacent carbons in the carbon chain of said fatty acid, and wherein said C₄₋₆ polyol ester has the following structure: 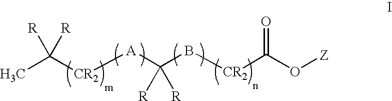
wherein,
A and B are selected from the group consisting of:
—(CR₂)—, —(CR═CR)— and 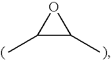
wherein at least one of A or B is 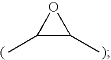
R in each instance is independently selected from the group consisting of: hydrogen, hydroxy(C₁₋₁₀)alkyl, amino(C₁₋₁₀)alkyl, C₁₋₁₀ alkyl, C₁₋₁₀ alkoxy, C₆₋₁₀ aryl, hydroxy, heteroaryl, C₃₋₆ cycloalkyl and phenyl(C₁₋₄)alkyl;
m is an integer between about 2 and about 10;
n is an integer between about 2 and about 10; and
Z is selected from the group consisting of:
a residue of a monosaccharide, 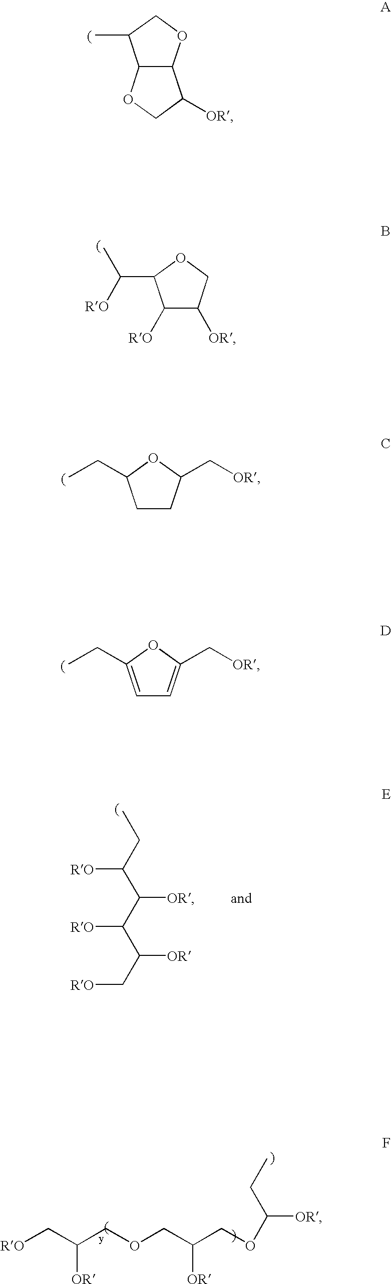
wherein R′ is in each instance independently selected from the group consisting of hydrogen, carboxyallylic, carboxy(C₁₋₅)alkyl, C₁₋₅ alkyl and 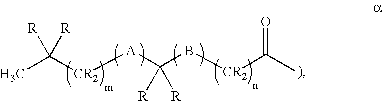
wherein R, A, B, m and n are as described above.

62. The ester of claim 61, wherein said C₄₋₆ polyol ester is derived from a monosaccharide.

63. The ester of claim 61, wherein said C₄₋₆ polyol ester is derived from sorbitol, sorbitan or isosorbide.

64. The ester of claim 61, wherein said C₄₋₆ polyol is derived from hydroxymethyl furfural.

65. The ester of claim 61, wherein said vegetable oil fatty acid is derived from soy, corn, sunflower or linseed oil.

66. The ester of claim 61, wherein
R in each instance is independently hydrogen, hydroxy(C₁₋₁₀)alkyl,
or amino(C₁₋₁₀)alkyl, and
R′ is hydrogen.

67. The ester of claim 61, wherein
m is an integer between about 2 and about 5, and
n is an integer between about 4 and about 7.

68. A method of lowering the glass transition temperature, T_{g}, of a composition comprising a polymer having a first T_{g}, said method comprising:
combining said composition comprising a polymer and the ester of claim 61, wherein said first T_{g} is lowered by not less than about 2° C.
